(19) United States
(12) Patent Application Publication
(10) Pub. No.: US 2022/0253879 A1
(43) Pub. Date: Aug. 11, 2022

(54) Reward System and Method for restaurants

(71) Applicant: Wei Chang Jack Huang, Pasadena, CA (US)

(72) Inventor: Wei Chang Jack Huang, Pasadena, CA (US)

(21) Appl. No.: 17/728,818

(22) Filed: Apr. 25, 2022

Related U.S. Application Data
(63) Continuation-in-part of application No. 16/941,551, filed on Jul. 29, 2020, now abandoned.

(51) Int. Cl. G06Q 30/02; G06Q 50/12

(52) U.S. Cl. CPC G06Q 30/0212; G06Q 30/0235; G06Q 50/12

(57) ABSTRACT

A reward method comprises steps of: a) receiving, by the network connecting device, a network connection request from the wireless communication device to establish a network connection following the network connection guide; b) requesting and receiving, by the server device via the wireless communication device, at least one identification data including, but not limited to, membership number, booking number, and Facebook account number of the consumer; c) storing the identification data to the memory device; d) providing a chance of lucky draw to the wireless communication device via the network connecting device according to at least one waiting time/connect criterion; e) receiving, by the server device via the network connecting device, the wireless communication device's exercise of the chance of lucky draw, and executing the lucky draw; f) wirelessly transmitting prize information resulting from the lucky draw to the wireless communication device. Also disclosed is a corresponding reward system.

### FIELD

Embodiments of the disclosure relate to a reward method, and more particularly relate to a reward system for restaurants and a reward method for restaurants.

### BACKGROUND

In today's world, businesses, irrespective of which industry they are in, rely more and more on information of all sorts. The service industry has a rapidly changing market, in which packaging of products, ways of marketing, and contents of products are equally important. Specifically, customers of restaurants may be generally categorized into repeat customers and transient customers. To boost the sales of a restaurant, efforts should be made to motivate undecided transient customers or passerby to walk-in more frequently, and also to enhance the visit/dining experience of repeat customers.

Currently, the worldwide pandemic represses going-out consumption. In the Internet age, most consumers have personal communication devices such as mobile phones or smart watches; however, due to privacy considerations, they are reluctant to provide personal data. Therefore, marketing efforts should be directed to stimulating customers to voluntarily provide their personal information when they walk-in to dine, which facilitates the restaurant to summarize customers' spending, build up confidence from customers, and promote repeat patronage.

Typically, a restaurant will provide special incentive offers from time to time so as to drive short-term sales and attract a large group of transient consumers and passersby; if the promotions go well, additional transient consumers arising during the promotion period may be turned into repeat customers. Psychological researches reveal that a randomly-based lucky draw or lottery games can be more effective in boosting psychological satisfaction of rewarded customers than those routine and predictable rewards. Therefore, by offering rewards to a certain proportion of consumers through a lucky draw game provided by a background server device, it not only adds fun to consumers, but also may appease those pre-booking or takeout customers who become impatient and agitated in waiting. The lucky draw game may offer a favorable chance of winning to repeat customers whereby to reward their loyalty.

Like airports or hotels which usually provide free Wi-Fi to passengers and guests but require registration, a restaurant may also provide free, registered-to-access Wi-Fi within its premise, whereby to offer waiting customers a chance to participate in the lucky draw game; in this way, the restaurant may easily obtain personal information of potential consumers for subsequent marketing and survey. The free Wi-Fi approach not only caters to consumers' habits without compromising their privacy, but also facilitates the merchant to review its marketing efforts. Therefore, the restaurant industry has a need to leverage the interactivity of a lucky draw game to mitigate impatience of waiting customers, enhance consumption intent of potential consumers, and obtain personal profiles of consumers and potential consumers to offer restaurant operators an insight into market trend.

### SUMMARY

In some embodiments, a reward method for restaurants is provided, which enables a restaurant to collect data about a consumer or potential consumer for future survey by leveraging a network connecting device to connect a wireless communication device of the consumer or potential consumer to a server device and to send personal data of the consumer or potential consumer to the server.

In some embodiments, a reward method for restaurants is provided, which appeases consumer dissatisfaction and enhances consumer experience by computing waiting time and providing a chance of lucky draw to a waiting consumer.

In some embodiments, a reward method for restaurants is provided, which enables online order with identification data provided by a consumer, reduces the consumer's waiting time, and meanwhile enables the consumer to ease away the boredom time by rewarding the consumer a chance of lucky draw.

In some embodiments, a reward system for restaurants and a corresponding method are provided, wherein the consumer's identification and consumption data are stored, enabling prizes from a lucky draw to be adjustable to cater more to the consumer's preferences, thereby realizing a mutual beneficial consumption experience.

In some embodiments, a reward system for restaurants and a corresponding method are provided, wherein a consumer may easily select and complete to-go ordering and lucky draw by scanning a QR code to access a restaurant's website interface, thereby saving transaction time and cost.

In some embodiments, a reward system for restaurants and a corresponding method are provided, wherein by providing free Wi-Fi to consumers, the restaurant obtains the consumers' consumption data; with offer of online lucky draw, a mutual beneficial transaction is realized.

In some embodiments, a reward system for restaurants is provided, configured for a restaurant to offer a lucky draw to at least one consumer who has a wireless communication device using a reward system for restaurants; the system comprises: a display device configured to display at least one network connection guide; a network connecting device, to which the wireless communication device of the consumer is connected following the network connection guide, and via which a chance of lucky draw is offered to the wireless communication device; a server device connected to the wireless communication device, configured to obtain the consumer's identification data and execute the lucky draw; and a memory device connected to the server device, configured to store the identification data.

In some embodiments, a reward method for restaurants is provided, configured for a restaurant to offer a lucky draw to at least one consumer using a reward system for restaurants, wherein the reward system comprises a display device, a network connecting device, a memory device, and a server device, wherein the display device displays at least one network connection guide following which a network connection is established between a wireless communication device of the consumer and the network connecting device; the method comprises steps of: receiving, by the network connecting device, a network connection request from the wireless communication device following the network connection guide so as to establish a network connection; requesting and receiving, by the server device via the wireless communication device, at least one identification data including, but not limited to, membership number, booking number, and Facebook account number of the consumer; storing the identification data to the memory device; offering via the network connecting device a chance of lucky draw to the wireless communication device according to at least one waiting time/connect criterion; receiving the wireless communication device's exercise of the chance of lucky draw via the network connecting device, and executing the lucky draw by the server device; and wirelessly transmitting prize information resulting from the lucky draw to the wireless communication device.

In the reward system for restaurants and the corresponding method disclosed by the disclosure, the network connecting device enables network connection with the consumer's wireless communication device following the network connection guide and enables reception of the consumer's identification data; a chance of lucky draw is fed back to the wireless communication device via the network connecting device, wherein the lucky draw is executed by the server device; the wireless communication device is informed, via the network connecting device, of prize information resulting from the lucky draw. The lucky draw program motivates the consumer to provide his/her identification data, while the consumer obtains discounts and other rewards from participating in the lucky draw; in this way, the restaurant and the consumer reach a mutually beneficial deal. The lucky draw game enables the restaurant owner to gain more insights into the consumer's preferences and boosts the consumer's intent to participate in the lucky draw game and walk in to dine. The disclosure resolves the issue of lacking mutual benefits in a non-interacting lucky draw program and facilitates the restaurant owner to obtain specific consumer profiles with consent from the consumer while maintaining the consumer's privacy.

### BRIEF DESCRIPTION OF THE DRAWINGS

FIG. 1 is a flow chart of a reward system for restaurants according to a first example of the disclosure.

FIG. 2 is a schematic diagram of a reward system for restaurants corresponding to the example of FIG. 1.

FIG. 3 is a flow chart of a reward method for restaurants according to a second example of the disclosure.

FIG. 4 is a schematic diagram of a reward system for restaurants corresponding to the example of FIG. 3.

FIG. 5 is a schematic diagram of a reward system for restaurants according to a third example.

### DETAILED DESCRIPTION

The above and other technical contents, features and benefits of the disclosure will become apparent through the following detailed explanation of the embodiments with reference to the drawings; in addition, same or like reference numerals represent identical or corresponding components throughout examples.

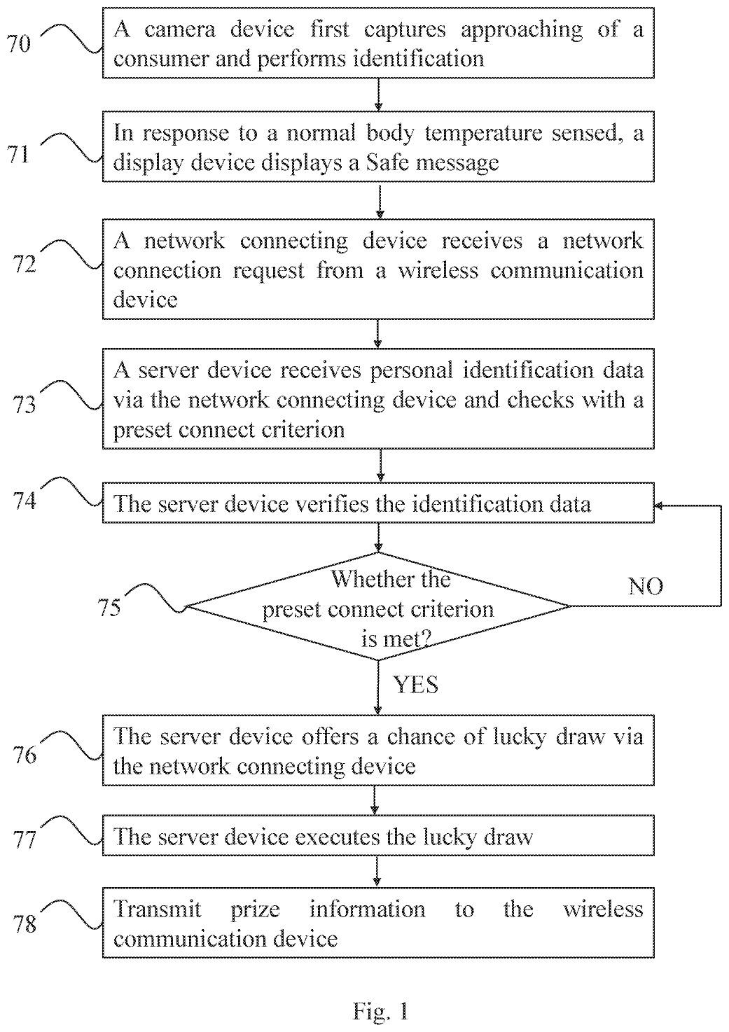

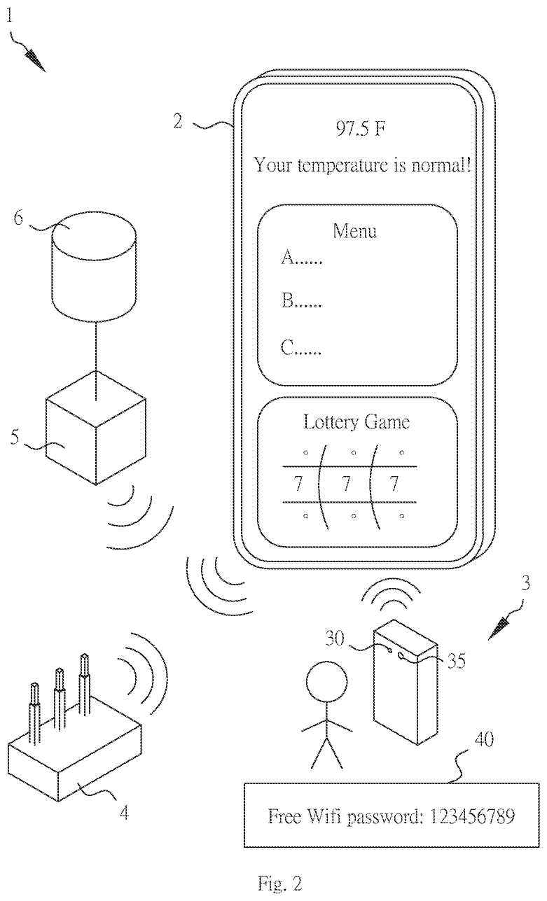

FIG. 1 illustrates a reward method for restaurants according to a first example of the disclosure, and FIG. 2 illustrates a corresponding reward system 1. The reward system 1 comprises: a display device 3, which refers to a flat panel touch display in this example; a network connecting device 4, which refers to a Wi-Fi router in this example; and a server device 5 and a memory device 6, which are remotely connected with the display device 3 and the network connecting device 4. The system 1 is configurable for a consumer to operate with a wireless communication device 2. A simple example of the wireless communication device 2 is a typical smart phone; however, the wireless communication device 2 may also be any communication device accessible to the Internet, such as a smart watch. The disclosure is not limited to specific types of the wireless communication device 2.

In this example, the consumer is a passerby. When a potential consumer passes by a restaurant and stops to browse menu items and prices, a camera device 30 disposed above the display device 3 in front of the restaurant may first capture approaching of the consumer and identify the consumer in step 70. During the pandemic such as COVID-9, an infrared body temperature sensing device 35 may be built in the camera device 30 to sense forehead temperature of the consumer. If the temperature sensing result is normal, the display device 3 further displays a Normal message in step 71. In this example, when the camera device 30 fails in face recognition, the display device 3 displays a message of asking the consumer to take off the mask or hat; when the body temperature sensing device 35 senses that the temperature is abnormal, the display device displays a Suspected Fever alert. This configuration may screen feverish customers to prevent pandemic spread. It is understood that the temperature sensing feature and step may be canceled if temperature sensing becomes unnecessary.

In this example, the consumer might be a transient, first-time consumer. The consumer may access the merchant's website or App via his/her smart phone following a network connection guide 40 (which is a QR code in this example) displayed on the display device 3. In this example, since the restaurant provides free Wi-Fi, after the network connecting device receives a network connection request from the consumer in step 72, the website or App may first request the consumer to provide some personal identification data, and the remote server device 5 receives the personal identification data via the network connecting device 4 in step 73. The identification data may include membership account number, social networking application (such as FB) account number, and communication application (such as Line, WhatsApp) account number.

Now, the server device 5 will verify the identification data in step 74; in response to a successful verification in step 75, the server device 5 stores the identification data in the memory device 6 and determines whether the consumer meets a preset connect rule; in response to confirming that the consumer meets the preset connect rule, on one hand, the consumer may be allowed to freely use the wireless network; and on the other hand, the server device 5 sends the consumer one chance of lucky draw via the network connecting device 4 in step 76. When the server device 5 receives a message that the consumer exercises his/her chance of lucky draw via the network connecting device 4, the server device 5 executes the lucky draw in step 77, wherein prizes of the lucky draw may include, but are not limited to, discounts, cashbacks, and giveaways; and in step 78, the server device 5 stores prize information in the memory device 6 and transmits the prize information to the mobile phone via the network connecting device 4.

This instant feedback reward system is built on information communication between the consumer and the restaurant. On one hand, the restaurant may successfully attract the consumer to walk in to dine due to offering of appropriate discounts or giveaways won from the lucky draw; on the other hand, even if the potential consumer does not walk in, the restaurant may still obtain his/her personal data from the connection, which may be used for future marketing or survey. In this way, a mutually beneficial lucky draw solution is realized. Of course, in the disclosure, the lucky draw interface may not be displayed on the mobile phone webpage or APP, which may be displayed on a flat panel touch display. The disclosure is not limited thereto. It is noted that the form of lucky draw is not limited, which may be number match or various kinds of lottery games; as the form of lucky draw is not a focus of the disclosure, its examples will not be exhausted herein. Since the consumer's data have been stored in the memory device 6, the server device 5 may check the data to determine whether the customer is a temporary customer or a repeat consumer, and even know the consumer's habits and preferences, such that the restaurant may recommend potentially popular commodities to the consumer or adjust the contents of lucky draw to avoid a situation that the consumer might view the prize as of little value. Without obtaining consumer profiles in advance, the above benefits cannot be achieved. Through data analysis, this lucky draw system captures the interests of consumers, which is a prominent benefit produced by the disclosure.

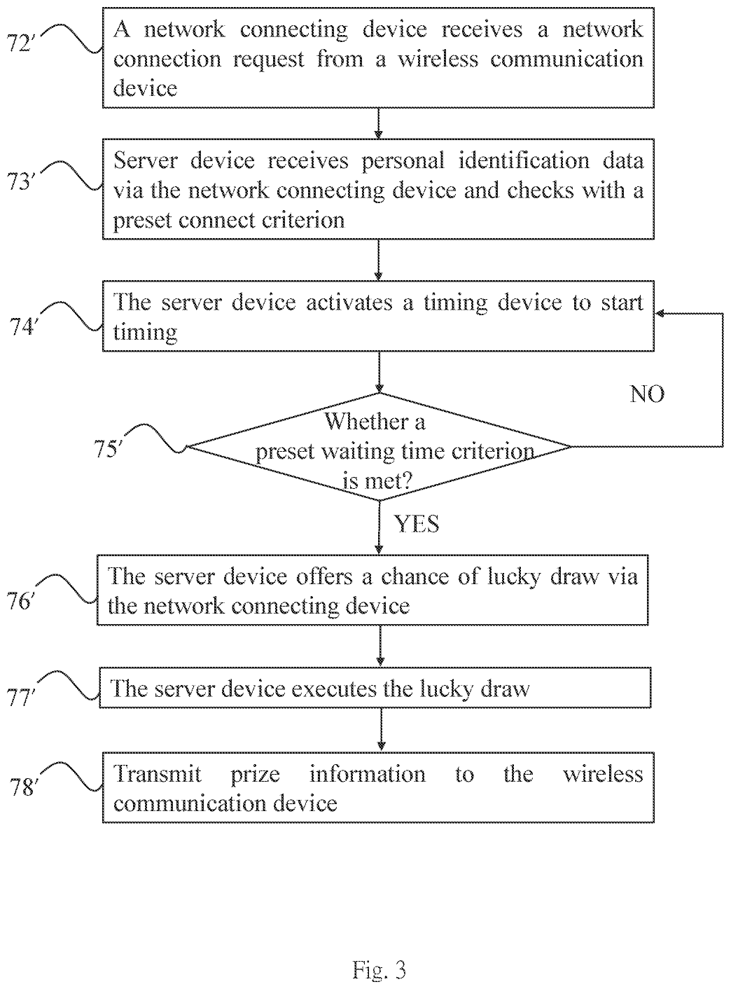

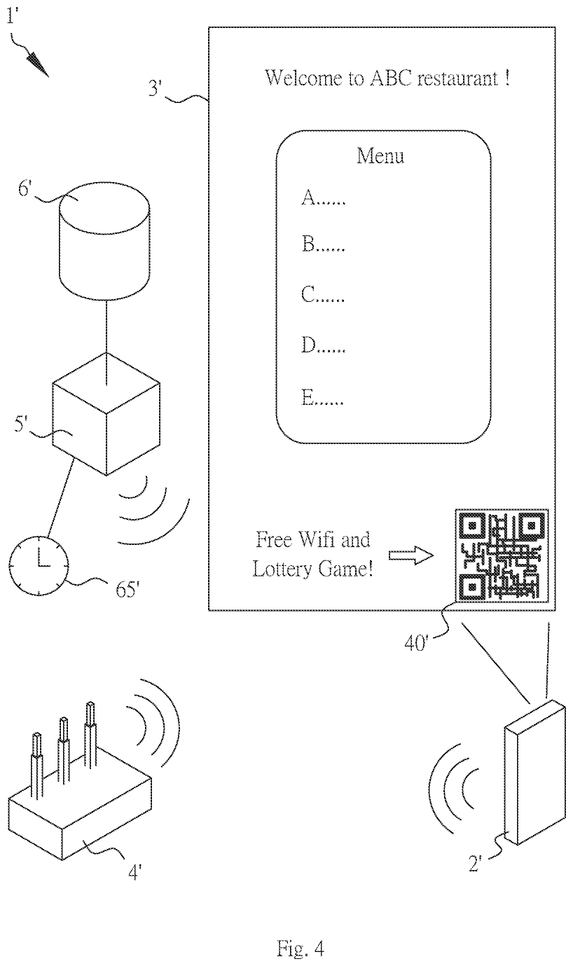

FIG. 3 illustrates a reward method for restaurants according to a second example of the disclosure, and FIG. 4 illustrates a corresponding reward system 1′, wherein the parts similar to the first example will not be detailed. The system 1′ in this example comprises a network connecting device 4′, a server device 5′, and a memory device 6′, which are also present in the first example, wherein the network connecting device 4′ is configured for a consumer to connect his/her wireless communication device 2′. Different from the first example, the display device 3′ in the second example is a paper poster displaying the menu of the restaurant as well as free Wi-Fi and network connection guide 40′ for accessing a lucky draw/lottery game, wherein the consumer uses a mobile phone to scan the QR code for network connection in step 72′, and in step 73′, the remote server device 5′ receives the consumer's personal data via the network connecting device 4′.

When the consumer ready to order is browsing the menu items or is waiting after ordering, or the consumer has obtained a pre-booking number through online ordering, the server device 5′ will confirm the connection and ordering information in step 74′, store the consumption data in a memory device 6′, and activate a timing device 65′ to start timing. Since it takes time to prepare the ordered dishes, the restaurant may preset for example ten minutes as a preset waiting time criterion; when the consumer's waiting time expires, the timing device 65′ alerts the server device 5′ in step 75′; to appease the impatient waiting consumer, the server device 5′ provides one chance of lucky draw to the consumer via the network connecting device 4′ in step 76′; later on, the consumer will be offered one chance of lucky draw for each ten-minute waiting, whereby to appease the impatient customer who waits for an overly long time. Then, lucky draw and prize information transmission are carried out in steps 77′ and 78′ in the same way as the preceding example. Although this example illustrates a paper menu and allows the consumer to access the restaurant's website or APP to order via his/her mobile phone, those skilled in the art may easily understand that a touch panel may be alternatively provided outside the restaurant for consumers to order.

In this example, when the consumer completes ordering, the timing device 65′ starts timing the waiting time; and estimated dish service time may also be displayed on the website accessed by the consumer's mobile phone; in this way, the consumer is psychologically ready for the waiting. With elapse of the waiting time, the server device 5′ will offer, via the network connecting device 4′, chances of lucky draw to the consumer as scheduled. If the dish service is delayed and the consumer becomes agitated due to the overly long waiting time, the restaurant will offer extra chances of lucky draw to the consumer. Of course, although the display device 3′ is a paper poster in this example, considering the scenario of online ordering as described above, the display device 3′ may be undoubtedly provided on a webpage or an APP interface. In this era of advanced visual technologies, the form of the display device 3′ is not limited, which does not depart from the scope of the disclosure.

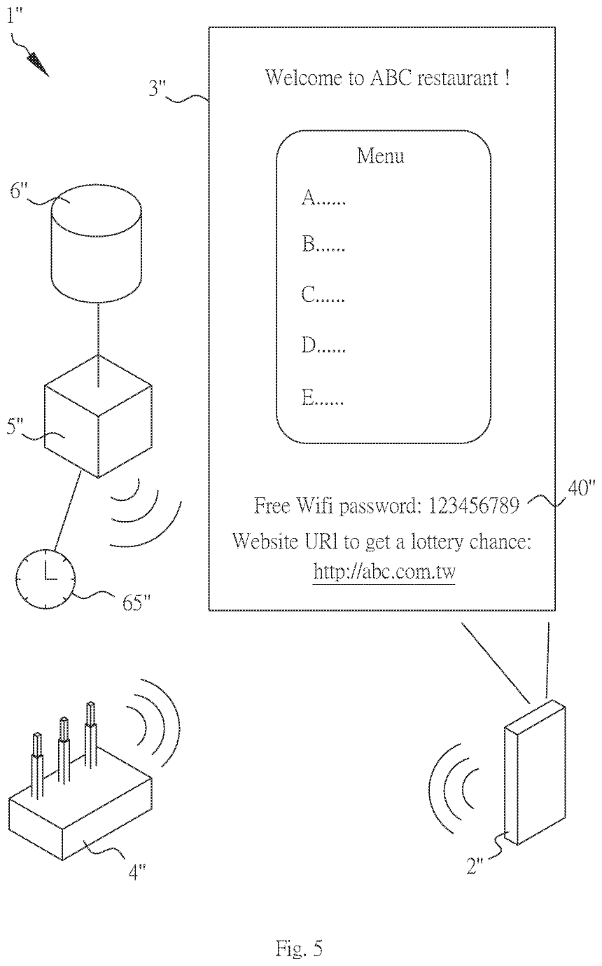

FIG. 5 illustrates a reward system 1″ for restaurants according to a third example of the disclosure, wherein the parts similar to the preceding two examples will not be described in detail. In this example, the consumer is a pre-booking customer. When the pre-booking customer arrives, the camera device (not shown) disposed above a display device 3″ in front of the restaurant may first capture approaching of the customer, identifying him/her, and sensing his/her temperature. Since the consumer in this example has booked in advance, he may follow the network connection guide 40″ displayed on the display device 3″ to access the restaurant's website or App via network connection to check in with his or her wireless communication device 2″; the server will check the reservation information on the website or App with the identification data of the pre-booking customer stored in the memory device, whereby to confirm arrival of the consumer; the server may further provide the Wi-Fi password to the consumer, offering him/her the right to use the wireless network freely.

If the consumer arrives earlier or the previous customers still occupy the table he/she books such that the consumer has to wait, the server device 5″ will activate a timing device 65″ to start timing after successfully checking with the identification data pre-stored in the memory device 6″; likewise, in response to the waiting time reaching a preset waiting time criterion, the server device 5″ offers the consumer one chance of lucky draw via the network connecting device 4″, whereby to appease the impatient consumer who waits for an overly long time.

Of course, those skilled in the art may easily understand that, in a harsh weather, the restaurant manager may adjust the winning odds of the lucky draw via the server device 5″. For example, if the consumer steps into the restaurant in a blizzard or burning sun or the consumer has waited for more than 30 minutes, the server device 5″ may offer a special discount as the prize. Of course, in the disclosure, the lucky draw interface is not necessarily displayed on a mobile phone webpage or APP, which may also be displayed on a flat panel touch display. The disclosure is not limited thereto.

The timing operation after network connection or consumption confirmation not only enables obtaining of consumers' contact information, but also enables maintaining of consumers' consumption experience, even enables promotion of consumption, thereby achieving the objectives of the disclosure. What have been described are only examples of the disclosure, which shall not constitute limitation to the scope of the disclosure. Any equivalent transformations and modifications simply made on the basis of the scope of the disclosure and the contents of the specification of the disclosure shall fall within the scope sought for protection by the disclosure.

I/We claim:

1. A reward method for restaurants, configured for a restaurant to offer lucky draw to at least one consumer using a reward system for restaurants, wherein the reward system comprises a display device, a network connecting device, a memory device, and a server device, wherein the display device displays at least one network connection guide, and a wireless communication device of the consumer is adaptable to connect to the network connecting device following the network connection guide; the method comprises steps of:
a) receiving, by the network connecting device, a network connection request from the wireless communication device to establish a network connection following the network connection guide;
b) requesting and receiving, by the server device via the wireless communication device, at least one identification data including, but not limited to, membership number, booking number, and Facebook account number of the consumer;
c) storing the identification data to the memory device;
d) providing a chance of lucky draw to the wireless communication device via the network connecting device according to at least one waiting time/connect criterion;
e) receiving, by the server device via the network connecting device, the wireless communication device's exercise of the chance of lucky draw, and executing the lucky draw;
f) wirelessly transmitting prize information resulting from the lucky draw to the wireless communication device.

2. The reward method for restaurants of claim 1, wherein the consumer refers to a pre-booking customer and the memory device stores corresponding reservation information, and wherein when the server device receives the identification data via the network connecting device in step b), the server device confirms that the identification data matches the reservation information.

3. The reward method for restaurants of claim 2, wherein the reward system for restaurants further comprises a timing device, and the memory device stores a preset waiting time criterion, such that when the timing device computes that the pre-booking customer's waiting time has met the waiting time criterion in step d), the chance of lucky draw is offered.

4. The reward method for restaurants of claim 1, wherein the consumer refers to a customer who has completed consumption and is waiting for takeout, and the memory device stores information corresponding to the consumption, and wherein when the server receives the identification data via the network connecting device in step b), the server confirms that the identification data matches the information corresponding to the consumption.

5. The reward method for restaurants according to claim 4, wherein the reward system for restaurants further comprises a timing device, and the memory device stores a preset waiting time criterion, such that when the timing device computes that the takeout customer's waiting time has met the waiting time criterion in step d), the server offers a chance of lucky draw.

6. The reward system for restaurants according to claim 1, wherein the network connecting device comprises a WiFi router controlled by the server device, and when the network connecting device receives a Wi-Fi connection in step b), the server device requests the identification data corresponding to the consumer, and the server device confirms match of the identification data, and then determines in step d) that the Wi-Fi connection meets the preset connect criterion, and authorizes the wireless communication device to connect to the Wi-Fi router.

7. A reward system for restaurants, configured for a restaurant to use a reward method for restaurants to offer lucky draw to at least one consumer who has a wireless communication device, wherein the reward system comprises:
a display device configured to display at least one network connection guide;
a network connecting device, to which the wireless communication device of the consumer is connected following the network connection guide, and via which the server offers a chance of lucky draw to the wireless communication device;
a server device connected to the wireless communication device, configured to obtain identification data of the consumer and execute the lucky draw;
and a memory device connected to the server device, configured to store the identification data.

8. The reward system for restaurants according to claim 7, further comprising a timing device connected to the server device, configured to compute consumer waiting time.
